(19) United States
(12) Patent Application Publication
(10) Pub. No.: US 2020/0069527 A1
(43) Pub. Date: Mar. 5, 2020

(54) ALIGNMENT APPARATUS FOR ALIGNING TABLETS, METHOD FOR ALIGNING TABLETS

(71) Applicant: Harro Hoefliger Verpackungsmaschinen GmbH, Allmersbach im Tal (DE)

(72) Inventor: Marco Weigel, Allmersbach im Tal (DE)

(21) Appl. No.: 16/548,484

(22) Filed: Aug. 22, 2019

(30) Foreign Application Priority Data
Aug. 28, 2018 (EP) 18191193.4

(51) Int. Cl. A61J 7/00; A61J 1/03

(52) U.S. Cl. CPC A61J 7/0076; A61J 1/035

(57) ABSTRACT

An alignment apparatus for tablets includes a shaft and a support arranged on the shaft. The shaft is rotatable relative to the support. The support has a supply channel for supplying tablets to the shaft. The shaft has an aligning groove for a tablet. The groove opens with its discharge end into a receiving pocket. A receiving point of the groove lies in the direction of the rotational axis at the same position as the supply channel. The discharge end is arranged laterally offset relative to the supply channel in the direction of the rotational axis. A distance between the supply channel and the groove increases continuously from the receiving point to the discharge end counter to the direction of rotation of the shaft. The support has a guide track which interacts with the groove for a guidance of the tablet axially parallel to the rotational axis of the shaft.

### CROSS REFERENCE TO RELATED APPLICATION

This application claims priority of European patent application no. 18 191 193.4, filed Aug. 28, 2018, the entire content of which is incorporated herein by reference.

### BACKGROUND OF THE INVENTION

Conventional packaging forms for tablets are, for example, what are known as blister strips into which the tablets are packed separately from one another. Tablets can furthermore also be filled as bulk material into bottle-like containers made of plastic or glass. Conventional filling devices guide the tablets to the packagings without aligning these into a defined position.

There are, however, applications in which the non-aligned supply of tablets is problematic. For example, there is a need to fill a specific number of tablets into two-piece capsules. Insofar as a circular tablet is only minimally smaller in terms of its diameter than the internal diameter of the lower part of the capsule to be filled, it can only be introduced in a horizontal, in other words coaxial position. On end or in another spatial orientation, the tablet would stick on the throat of the lower part of the capsule. One partial object furthermore lies in accommodating a certain number of tablets in the capsule. Insofar as one or more tablets come to lie on end in the lower part of the capsule, the inner space is not sufficient to receive all the tablets. It is only if all the tablets lie layered horizontally on one another that the pack dimension remains within a predetermined limit and only then can the filled capsule be properly closed. The same or similar problems can also occur in the case of other packaging types.

### SUMMARY OF THE INVENTION

It is an object of the invention to provide an alignment apparatus for tablets via which an aligned transfer of tablets into a target container becomes possible.

This object can, for example, be achieved by an alignment apparatus for tablets. The alignment apparatus includes: a shaft configured to be driven about an axis of rotation in a direction of rotation; a support arranged circumferentially on the shaft; the shaft being rotatable relative to the support; the support having a supply channel for the supply of tablets to the shaft; the shaft defining a circumference; the shaft defining at least one aligning groove in the circumference for the transport and alignment of a tablet; the at least one aligning groove having a receiving point and a discharge end; the aligning groove opening with the discharge end into a receiving pocket for a tablet; the receiving point of the aligning groove lying at a same position as the supply channel in a direction of the axis of rotation and the discharge end of the aligning groove being arranged laterally offset with respect to the supply channel in the direction of the axis of rotation; the supply channel and the aligning groove defining a local distance (a) measured in the direction of the axis of rotation; wherein the local distance (a) increases continuously from the receiving point to the discharge end counter to the direction of rotation of the shaft; and, the support having a guide track configured to interact with the aligning groove for a guidance of the tablet axially parallel to the axis of rotation of the shaft.

An alignment apparatus according to an embodiment includes a shaft and a support/supporting unit arranged circumferentially on the shaft. The shaft is rotatable relative to the supporting unit. The supporting unit has a supply channel for the supply of tablets to the shaft. The shaft has circumferentially at least one aligning groove for the transport and alignment of a tablet with a receiving point and with a discharge end. The aligning groove discharges with its discharge end into a receiving pocket for receiving a tablet. The receiving pocket is also formed circumferentially on the shaft. The receiving point of the aligning groove lies in the direction of the axis of rotation at the same position as the supply channel and the discharge end of the aligning groove is arranged laterally offset with respect to the supply channel in the direction of the axis of rotation. A distance measured in the direction of the axis of rotation between the supply channel and the aligning groove increases continuously from the receiving point to the discharge end counter to the direction of rotation of the shaft. The supporting unit furthermore has a guide track which interacts with the aligning groove for a guidance of the tablet axially parallel to the axis of rotation of the shaft.

The function of an aligning apparatus/device according to the disclosure and an associated method for aligning individual tablets can be summarized as follows: in order to align a tablet, it is supplied via the supply channel of the supporting unit to the shaft. Here, the tablet falls under the action of gravity through the supply channel onto the shaft and remains lying there initially in the discharge region of the supply channel. The term “gravity” should be understood within the meaning of the application as gravitational acceleration. However, a mechanically driven supply can also, for example, be expedient, for example, in the horizontal direction without the use of gravity. In any event, as a result of the rotation of the shaft and the profile described above of the aligning groove, its receiving point initially comes to overlap with the supply channel. The tablet is thus gripped at the receiving point by the aligning groove, but prevented from co-rotating by the guide track of the supporting unit. The supporting unit only permits a substantially axially parallel movement of the tablet. The tablet is caused to move in interaction therewith. It moves along the current point of intersection of the aligning groove with the guide track. As a result of the increasing local axial distance of this aligning groove, this point of intersection migrates from the receiving point to the discharge end. In a similar manner and at the same point, the tablet also migrates from the supply channel to the discharge end and finally into the receiving pocket. The mutual interaction of guide track and aligning groove also leads, in addition to the above transport action, to the possibly initially upright tablet tipping over and finally coming to lie flat in the discharge region of the aligning groove or in the receiving pocket. In other words, the initial alignment of the tablet is not important. The tablets can be supplied in any desired spatial orientation. Independently of their initial spatial orientation, each individual tablet is aligned into a flat position from which it can then be removed and transferred in the aligned state into the target container.

The rotational movement of the shaft is preferably discontinuous or, in other words, clocked. This enables a simplified synchronization of the rotational movement of the shaft with the tablet supply and also with tablet removal. The method can, however, alternatively also be carried out in the case of continuous rotational movement.

The aligning groove runs preferably in an arcuate manner from its receiving point to its discharge end. It has been shown that the rolling of tablets along the aligning groove is facilitated by the arcuate configuration.

It can advantageously be provided that the aligning groove has an effective depth measured in the direction radial to the axis of rotation, which depth increases from the receiving point towards the discharge end counter to the direction of rotation of the shaft. The effective depth of the aligning groove describes the distance measured in the direction radial to the axis of rotation by which the tablet drops from the circumferential side of the shaft into the aligning groove. The tablet is guided better in the aligning groove with increasing effective depth. In particular, it is achieved that the change in position of a possibly vertical tablet into the desired uniform lying alignment is performed gently and without high mechanical strain on the tablet.

Various options are considered for the configuration of the guide track. The guide track of the supporting unit may preferably include an upright supporting wall which is arranged parallel to the axis of rotation circumferentially on the shaft. Upright positioning of the supporting wall means here that, during operation, it is substantially parallel to the direction of gravity and thereby runs approximately tangentially to the surface of the shaft. As seen in cross section, a channel in which the tablet comes to lie is formed between supporting wall and shaft surface. As a result of this, the gravity acting on the tablet can be used for supply through the supply channel and for the positioning and alignment on the shaft in the aligning groove and relative to the guide track without further technical precautions being required for this purpose.

The guide track of the supporting unit can preferably include two delimiting sides which face one another and run perpendicular to the axis of rotation, wherein the first delimiting side is arranged adjacent to the receiving point and the second delimiting side is arranged adjacent to the discharge end of the aligning groove. The delimiting sides delimit a bearing region in the direction of the axis of rotation. The aligning groove extends in the direction of the axis of rotation across the entire bearing region. As a result of the delimiting sides, it is ensured that the tablet does not fall out of the bearing region or move out of it during rotation of the shaft, that it subsequently therefore always remain in the region of action of the aligning groove.

It can advantageously be provided that the alignment apparatus includes a vacuum supply unit for the provision of vacuum and that the receiving pocket has an intake bore which can be connected to the vacuum supply unit in a flow- or pressure-transmitting manner. A negative pressure is generated via the vacuum supply unit at the intake bore of the receiving pocket. As a result, the tablet is held at the intake bore of the receiving pocket via a vacuum. In a further embodiment, the vacuum is then applied at this point if the tablet has come to lie in the receiving pocket. The vacuum is in particular switched off when the transfer position is reached, at the latest, however, shortly before the next tablet slips into the receiving pocket. In contrast to a constantly present vacuum, it is achieved by the activated vacuum that the tablet slips completely into its pocket and in this manner position deviations are avoided during the transfer of the tablet. The tablet is fixed in the receiving pocket in every position of the shaft. Even if the receiving pocket is directed downwards, the tablet remains fixed on the shaft counter to its gravitational force. An undesired removal of the tablet from the receiving pocket is thus avoided. In an optional further embodiment, it can be expedient that the intake bore is surrounded by an intake pocket. In the case of a large active cross section of the intake pocket, a high intake force can be achieved, while simultaneously the cross section of the intake bore and thus the associated intake air throughput can be kept small.

The alignment apparatus may include a gripping unit for removal of the respective tablet from the receiving pocket. For this purpose, the shaft is rotated into the transfer position, the tablet is caught via the gripping unit and removed from the receiving pocket. The tablet is transferred in a defined position in the receiving pocket of the gripping unit, as a result of which the tablet can be handed on in a targeted manner via the gripping unit. For example, a filling of a capsule, the stacking of tablets, et cetera can thus be carried out via the gripping unit. The gripping unit can expediently have at least two gripping arms, in particular at least three gripping arms, and preferably four gripping arms. It can, however, also be advantageous to provide a different number of gripping arms, for example, as a function of the tablet size. The at least two gripping arms may advantageously be formed to be resilient. During gripping of the tablet, the gripping arms contact the tablet circumferentially. The gripping arms are bent outwards resiliently in the radial direction from the center of the tablet and hold the tablets tight passively via a clamping force. The tablet can then be removed from the receiving pocket, wherein the clamping force formed by the resilient gripping arms is larger than the intake force resulting from the negative pressure on the intake bore. Alternatively, the tablet can also be received by an active gripping unit.

### BRIEF DESCRIPTION OF THE DRAWINGS

The invention will now be described with reference to the drawings wherein:

FIG. 1 shows, in a perspective representation, an alignment apparatus with a shaft, with a supporting unit and with a supplied, but not yet aligned, tablet;

FIG. 2 shows, in a perspective representation, the shaft of the alignment apparatus according to FIG. 1 with an aligning groove and details of their geometric configuration;

FIG. 3 shows, in a side view, the alignment apparatus according to FIG. 1 with details for opposite positioning of shaft and supporting unit;

FIGS. 4A and 4B show, in perspective representations, the alignment apparatus according to FIGS. 1 to 3 in various bearing positions of the tablets;

FIGS. 5A to 5D show, in perspective representations, the alignment apparatus according to the previous figures in various shaft positions and alignment stages of the tablet; and,

FIGS. 6A to 6C show, in perspective representations, the alignment apparatuses according to the previous figures during removal of the aligned tablet via a gripping unit.

### DESCRIPTION OF THE PREFERRED EMBODIMENTS OF THE INVENTION

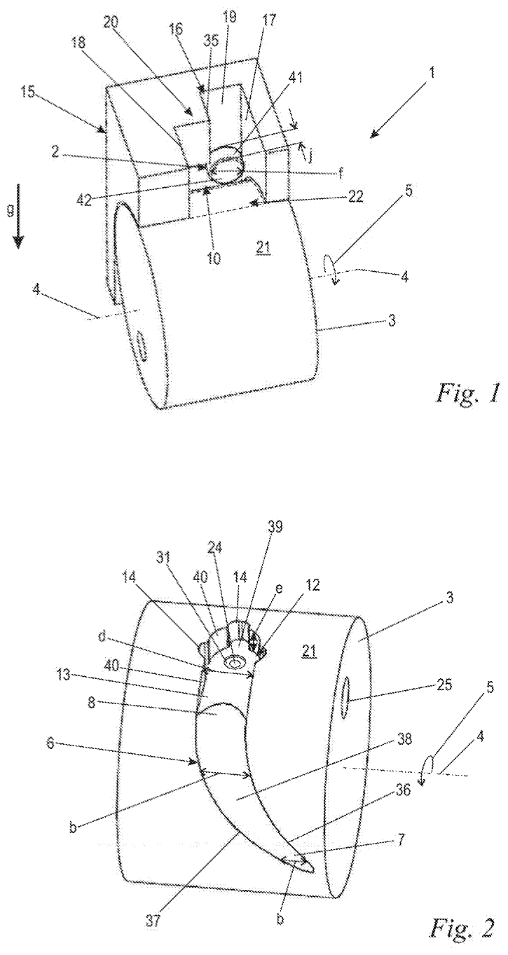

An alignment apparatus 1 provided as a component of a filling apparatus, not represented, for tablets 2, is shown in FIG. 1. In the concrete case, alignment apparatus 1 is a component of a capsule machine, in the case of which several tablets 2 are aligned and filled into two-part capsules with their flat sides stacked on top of one another. Tablet 2 can be a pharmaceutical preparation or a food supplement.

As shown in FIG. 1, alignment apparatus 1 includes a shaft 3 which can be driven about an axis of rotation 4 in one direction of rotation 5, and a supporting unit 15 arranged circumferentially on shaft 3. Shaft 3 is mounted rotatably relative to supporting unit 15. Under rotation of shaft 3, a tablet 2 supplied to shaft 3 is aligned between shaft 3 and supporting unit 15 into a defined position and provided for further processing. As a result of the defined position, tablet 2 can be stored in a targeted manner in corresponding packagings. As a result of this, for example, a stacking of tablets 2 and a jam-free storage in particular in the lower part of the two-part capsule is enabled. In the case of blister packs or other packagings, tablets 2 can be stored in a targeted manner in corresponding cavities with very narrow tolerances.

As shown in FIG. 1, supporting unit 15 includes a supply channel 16 via which tablets 2 can be supplied to shaft 3. In the embodiment, supply channel 16 is aligned parallel to gravity g. It can, however, also be expedient to form supply channel 16 running on an incline with respect to gravity g. Supporting unit 15 furthermore includes a first delimiting side 17 and a second delimiting side 18. Both delimiting sides 17, 18 face one another and delimit a bearing region 22 in the direction of axis of rotation 4. Supporting unit 15 furthermore has an upright supporting wall 19 which is arranged circumferentially on shaft 3 and delimits bearing region 22 circumferentially with respect to shaft 3. Supporting wall 19 connects both delimiting sides 17, 18 to one another. Tablet 2 is thus secured by supporting wall 19 and both delimiting sides 17, 18 in bearing region 22 of shaft 3 and can as a result not slip or fall off shaft 3. Both supporting wall 19 and the two delimiting sides 17, 18 extend in the embodiment parallel to the direction of gravity g, but an alignment running at an incline with respect to gravity g can be expedient.

Supporting unit 15 also has a guide track 10 for guidance of tablet 2 axially parallel to axis of rotation 4 of shaft 3, wherein this guide track 10 interacts with an aligning groove 6 represented in FIG. 2 and described in greater detail below. Part of guide track 10 is stated supporting wall 19 which, together with the circumferential surface of shaft 3, forms a channel running axially parallel to axis of rotation 4. The channel acts as stated guide track 10. The tablet comes to lie in it and it can be moved in it parallel to axis of rotation 4 without being carried along in the circumferential direction by the rotational movement of shaft 3.

As shown in FIG. 1, an aligning projection 20 is formed on supporting wall 19 of supporting unit 15. Aligning projection 20 has a projection side 35 which faces first delimiting side 17. Supply channel 16 is formed from projection side 35, first delimiting side 17 and at least partially from supporting wall 19. Tablet 2 is guided, when falling through supply channel 16, onto shaft 3 by first delimiting side 17 and projection side 35 in the direction of axis of rotation 4 and by supporting wall 19 circumferentially to shaft 3. Aligning device 20 can, however, be so far distant in the vertical direction from guide track 10 that it does not touch tablet 2 during the alignment process. Where applicable, aligning projection 20 can be entirely omitted.

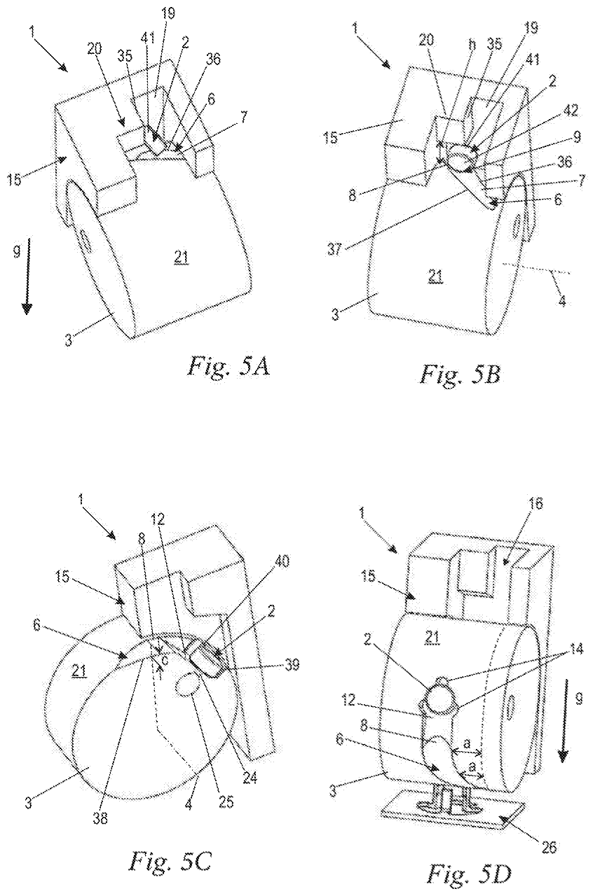

Shaft 3 of alignment apparatus 1 from FIG. 1 is shown in a perspective representation in FIG. 2. Shaft 3 circumferentially has an aligning groove 6. Aligning groove 6 extends from a receiving point 7 up to a discharge end 8. At discharge end 8, aligning groove 6 discharges into a receiving pocket 12 which serves to receive tablet 2. Receiving point 7 of aligning groove 6 lies in the direction of axis of rotation 4 at the height of supply channel 16, that is, in the direction of axis of rotation 4 at the same position as supply channel 16 (FIG. 5A), discharge end 8 of aligning groove 6 being arranged laterally offset with respect to supply channel 16 in the direction of axis of rotation 4 towards second delimiting side 18. Both receiving point 7 of aligning groove 6 and its discharge end 8 lie in the direction of axis of rotation 4 at the height of bearing region 22. Here, in the direction of axis of rotation 4, first delimiting side 17 is arranged adjacent to receiving point 7 and second delimiting side 18 is arranged adjacent to discharge end 8 of aligning groove 6. Aligning groove 6 has a local distance a measured in the direction of axis of rotation 4 to supply channel 16 (FIG. 5D) which continuously increases from receiving point 7 towards discharge end 8 of aligning groove 6 counter to direction of rotation 5 of shaft 3. Aligning groove 6 extends from its receiving point 7 up to its discharge end 8 continuously both in the direction of axis of rotation 4 and in the circumferential direction or in direction of rotation 5. Aligning groove 6 accordingly has no portion only running parallel to axis of rotation 4. In the embodiment, aligning groove 6 has an arcuate profile. However, differently shaped profiles of aligning groove 6 can also be expedient.

As shown in FIG. 2, aligning groove 6 is delimited on circumferential side 21 of shaft 3 by two groove edges 36, 37. Here, first groove edge 36 is arranged close to first delimiting side 17 and second groove edge 37 is arranged close to second delimiting side 18. First groove edge 36 is furthermore arranged following second groove edge 37 in direction of rotation 5 of shaft 3. Aligning groove 6 furthermore has a groove width b which corresponds to the distance measured in the direction of axis of rotation 4 between groove edges 36, 37. Aligning groove 6 furthermore possesses a groove depth c (FIG. 5C) which corresponds to the maximum distance measured radially to axis of rotation 4 between groove base 38 and circumferential side 21 of shaft 3. Both groove width b and groove depth c increase starting from receiving point 7 towards discharge end 8 counter to direction of rotation 5 of shaft 3. In the embodiment, groove width b is larger than groove depth c at each circumferential portion. Aligning groove 6 furthermore possesses an effective depth 9 measured in the direction radial to axis of rotation 4 (FIG. 5B) which also increases from receiving point 7 towards discharge end 8 counter to direction of rotation 5 of shaft 3. Effective depth 9 of aligning groove 6 is produced from groove width c and groove depth b and corresponds to a distance measured in the direction radial to axis of rotation 4 by which tablet 2 drops from circumferential side 21 of shaft 3 into aligning groove 6. The lower tablet 2 drops into aligning groove 6, the better tablet 2 is guided in aligning groove 6.

As shown in FIG. 2, aligning groove 6 discharges with its discharge end 8 into a receiving pocket 12. Receiving pocket 12 has a flat pocket base 13 which lies in a plane which is spanned by a secant of the cylindrical shaft circumference and by a parallel to axis of rotation 4. Receiving pocket 12 is delimited on the outside of adjacent discharge end 8 circumferentially by high sides 40 which define a width d of receiving pocket 12 measured in the direction of axis of rotation 4. Width d of receiving pocket 12 is slightly larger than diameter f of tablet 2. As a result, a sliding of tablet 2 into receiving pocket 12 is ensured without tablet 2 being tilted or catching on high sides 40 of receiving pocket 12. Receiving pocket 12 extends from discharge end 8 of aligning groove 6 up to a pocket end 39 which serves as a defined stop of tablet 2. In the embodiment, pocket end 39 is partially rounded at high sides 40 running perpendicular to pocket base 13 in order to enable tablet 2 to rest flat via its circumferential side 41. Receiving pocket 12 furthermore has a depth e at its pocket end 39 which corresponds to the distance measured in the direction radial to axis of rotation 4 between pocket base 13 and circumferential side 21 of shaft 3. Depth e of receiving pocket 12 at its pocket end 39 corresponds approximately to thickness j of tablet 2.

Alignment apparatus 1 furthermore has a vacuum supply unit, not represented, which serves to provide vacuum. As shown in FIG. 2, shaft 3 is provided with a vacuum bore 25 which extends in the direction of axis of rotation 4 and which is connected to the vacuum supply unit in a flow- and pressure-transmitting manner. An intake bore 24 is furthermore provided in receiving pocket 12, which intake bore 24 extends from pocket base 13 to vacuum bore 25 of shaft 3 and which is connected via a pressure duct, not represented, to the vacuum bore. Intake bore 24 is accordingly connected via a vacuum bore 25 to the vacuum supply unit in a flow- and pressure-transmitting manner, as a result of which a vacuum for holding tablet 2 can be provided in receiving pocket 12 on intake bore 24. Flat pocket base 13 facilitates tablet 2 lying flat on the opening of intake bore 24 so that tablet 2 closes off intake bore 24 and a sufficiently high negative pressure for holding tablet 2 can be formed. Flat pocket base 13 is optionally provided in the region of intake bore 24 with a small suction pocket 31 which surrounds intake bore 24. Vacuum is present on tablet 2 distributed over the comparatively large active surface of the pocket in order to be able to effectively hold it and thus effectively counteract the radially acting force during rotation of shaft 3. At the same time, the cross section of intake bore 24 can be kept small, as a result of which only a small volumetric flow of air must be taken in to provide the negative pressure.

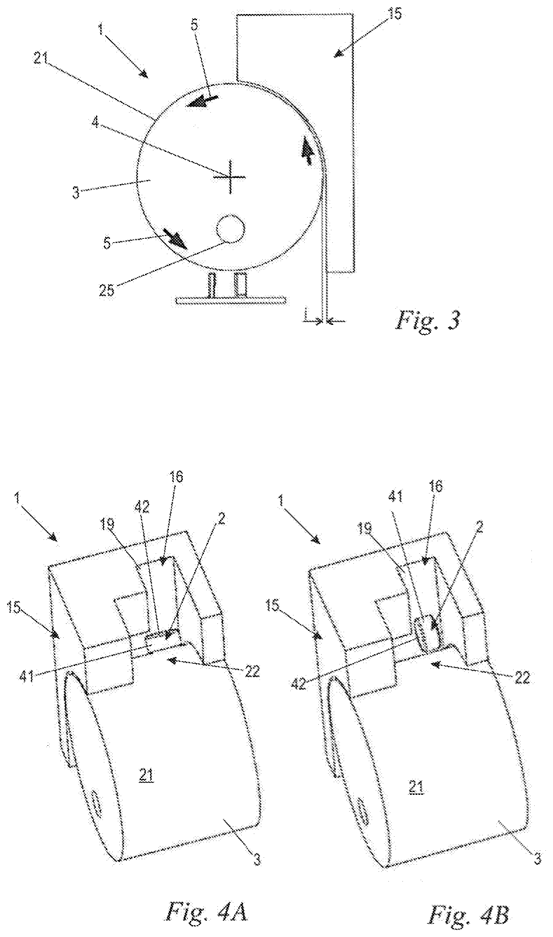

As shown in FIG. 3, supporting unit 15 and shaft 3 are arranged at a distance i from one another. Distance i is so large that shaft 3 and supporting unit 15 do not contact. Distance i is also smaller than thickness j of a tablet 2 so that tablet 2 remains lying in guide track 10 (FIG. 1) without falling through between shaft 3 and supporting unit 15. In order to enable a processing of tablets 2 of various thicknesses, it is expedient to provide on the aligning device a variably adjustable distance i between shaft 3 and supporting unit 15 in the direction of axis of rotation 4 at the height of bearing region 22.

An aligning method for a tablet is described below via alignment apparatus 1 according to the disclosure:

In order to align a tablet 2, it is supplied via supply channel 16 of supporting unit 15 onto shaft 3. Here, tablet 2 falls under the action of gravity g through supply channel 16 onto shaft 3. Tablet 2 subsequently slides and/or rolls on shaft 3 in the direction of supporting wall 19 and comes to rest on shaft 3 lying on supporting wall 19. As shown, for example, in FIGS. 1, 4A, 4B, tablet 2 can bear in different positions against supporting unit 15. In FIG. 1, tablet 2 bears with one of its base sides 42 lying against supporting unit 15. In this case, base side 42 runs approximately parallel to supporting wall 19 of supporting unit 15. Tablet 2 lies with its circumferential side 41 on circumferential side 21 of shaft 3. In FIG. 4A, in contrast, tablet 2 lies with its base side 42 on shaft 3 and is supported with its circumferential side 41 on supporting wall 19. In FIG. 4B, tablet 2 only contacts with its circumferential side 41 circumferential side 21 of shaft 3 and supporting wall 19 of supporting unit 15. Tablet 2 lies in all positions in bearing region 22 of shaft 2 at the height of supply channel 16.

As shown in FIGS. 1, 4A, 4B, shaft 3 is initially positioned during the supply of tablet 2 to shaft 3 in such a manner that aligning groove 6 is covered entirely or at least partially by supporting unit 15. After the supply of tablet 2, shaft 3 rotates in direction of rotation 5 of shaft 3, as shown in FIG. 3. Here, aligning groove 6 continuously rotates from its covered position under supporting unit 15 with the rotation of shaft 3.

FIGS. 5A to 5D show, in perspective representations, alignment apparatus 1 in a chronological profile during the alignment of a tablet 2. FIG. 5A shows shaft 3 in a position in which aligning groove 6 is at least partially freely rotated. In this position of shaft 3, receiving point 7 is located above discharge end 8 of aligning groove 6 so that aligning groove 6 runs continuously from receiving point 7 to its discharge end 8 downwards in the direction of gravity g. Tablet 2 slides under the action of gravity g along circumferential side 21 of shaft 3 into receiving point 7 of aligning groove 6 and is held at its circumferential side 41 in aligning groove 6 substantially on first receiving edge 36. Tablet 2 slides and/or rolls via gravity g along first groove edge 36 downwards until tablet 2 hits supporting wall 19.

Proceeding from a starting position of tablet 2 according to FIG. 4B, tablet 2 can be supported with its circumferential side 41 on projection side 35 and on supporting wall 19 and as a result can be moved during rotation of shaft 3 for tipping over insofar as aligning projection 20 is correspondingly configured. In such a case, it can be expedient to provide shaft 3 with a second aligning groove 6 offset in the circumferential direction. First circumferential groove 6 would then initiate the tipping over of tablet 2, while the subsequent circumferential groove, not shown here, ensures further transport of tablet 2. Since aligning projection 20 of supporting unit 15 in the embodiment shown, however, has a distance h measured in the direction of gravity g to circumferential side 21 of shaft 3 (FIG. 5B) which is larger than diameter f of tablet 2, it is possible for tablet 2 to slide under aligning projection 20 without contact with projection side 35. Aligning projection 20 therefore plays no role here for the alignment process. The tablet initially stands in an inherently stable manner with its circumferential side on the circumferential side of cylindrical shaft 3. As a result of the rotation of shaft 3, circumferential groove 6 now passes under tablet 2 which then initially comes to lie only on leading groove edge 37. The balance of tablet 2 is disturbed so that it tips over. With further rotation of shaft 3 into a position initially according to FIG. 5A and then according to FIG. 5B, tablet 2 is aligned with its base side 42 approximately parallel to axis of rotation 4 and lies in aligning groove 6. Tablet 2 sinks with progressing rotation of shaft 3 increasingly in aligning groove 6.

As shown in FIG. 5B, aligning groove 6 is further released from supporting unit 15 with progressing rotation of shaft 3. In this case, distance a measured in the direction of axis of rotation 4 between aligning groove 6 and supply channel 16 which increases counter to direction of rotation 5 brings about that tablet 2 is conveyed with rotation of shaft 3 in the direction of axis of rotation 4. Guided by first groove edge 36, tablet 2 slides and/or rolls from receiving point 7 to discharge end 8 of the aligning groove.

As shown in FIG. 5C, tablet 2 slides under rotation of shaft 3 from discharge end 8 of aligning groove 6 into receiving pocket 12. At pocket end 39 of receiving pocket 12, tablet 2 preferably lies flat on high sides 40, as a result of which tablet 2 is located in a defined alignment. In order to fix tablet 2 in this orientation, this is held via vacuum. For this purpose, vacuum is activated at intake bore 24 and at optional suction pocket 31 already mentioned above in conjunction with FIG. 2, as a result of which tablet 2 is fixed via the negative pressure in receiving pocket 12. The vacuum is provided by the vacuum supply unit which is connected via vacuum bore 25 of shaft 3 to intake bore 24 in a flow- and pressure-transmitting manner. The vacuum can be switched on and off as required via the vacuum supply unit. Permanent provision of vacuum may also be expedient. As FIG. 5D shows, shaft 3 can be rotated further into any desired transfer position by fixing tablet 2 via vacuum without tablet 2 falling off shaft 3 due to gravity g.

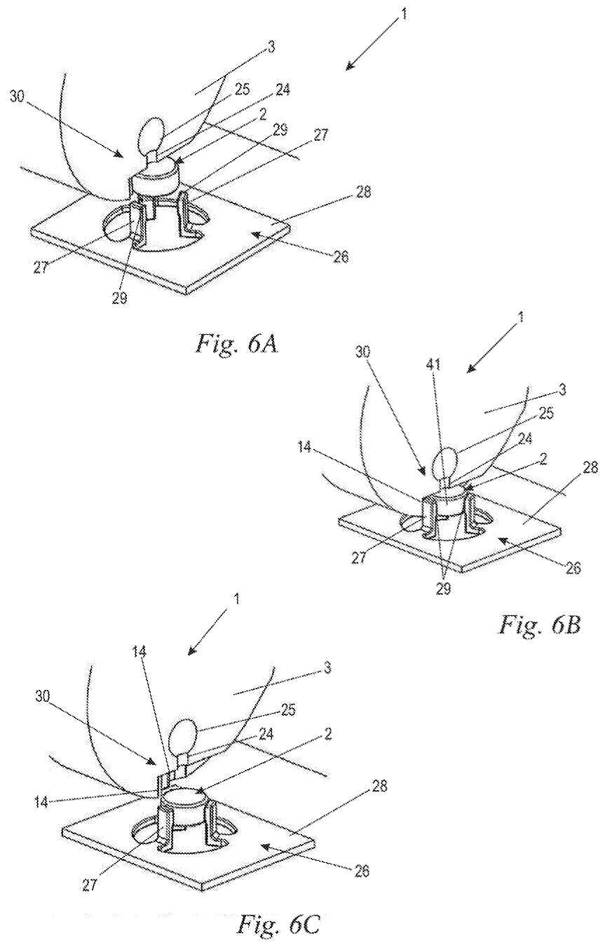

FIGS. 6A to 6C show a gripping process of a gripping unit 26 of alignment apparatus 1 in a transfer position 30. Gripping unit 26 is arranged circumferentially on shaft 3. In the embodiment, gripping unit 26 is arranged below shaft 3, but other arrangements of gripping unit 26 can also be expedient. In the embodiment, gripping unit 26 includes three gripping arms 27. In one alternative embodiment, a different number of gripping arms 27 can also be expedient. The number of gripping arms 27 can thus, for example, be adapted to diameter f of tablet 2. Gripping arms 27 are arranged on base plate 28 in a circular manner at an equal angle spacing. Gripping arms 27 are arranged resiliently on base plate 28 in the embodiment. The circular diameter formed by gripping arms 27 is slightly smaller than diameter f of tablet 2. It may also be expedient to provide actively moving gripping arms. These can, for example, via a mechanism, reduce and once again expand the circular diameter formed by them and thus actively grip and release the tablet. So that tablet 2 can be received by gripping arms 27, recesses 14 can be provided in receiving pocket 12 in accordance with the number of gripping arms 27. Gripping arms 27 can thus dip into recesses 14 and grip tablet 2.

In order therefore to transfer tablet 2 to gripping unit 26, shaft 3 moves into transfer position 30, as shown in FIG. 6A. In transfer position 30, tablet 2 is located directly opposite gripping unit 26. Gripping unit 26 travels in the direction of shaft 3 and dips with its gripping arms 27 into recesses 14 at receiving pocket 12. Since the diameter formed by gripping arms 27 is smaller than diameter f of tablet 2, gripping arms 27 contact tablet 2 at their ends 29. As shown in FIG. 6B, gripping arms 27 grip circumferential side 41 of tablet 2 at their ends 29 and are thereby slightly bent up. In this case, there is generated between gripping arms 27 and tablet 2 a clamping force which is sufficiently high to pull tablet 2 out of receiving pocket 12 counter to the intake force on intake bore 24. It can also be expedient to place the vacuum on intake bore 24 immediately after gripping of tablet 2 by gripping arms 27. As shown in FIG. 6C, gripping unit 26 finally travels with received tablet 2 out of receiving pocket 12 and provides tablet 2 for further processing. Shaft 3 can again be further rotated. The alignment process of a further tablet 2 can begin again via alignment apparatus 1.

In an advantageous further embodiment, the shaft 3 can also have several aligning grooves 6 arranged behind one another in the circumferential direction of shaft 3. The number of aligned tablets 2 can thus be increased for each revolution of shaft 3. It can furthermore be expedient to provide a longer shaft and provide several aligning grooves and supporting units along their axis of rotation. Thus, for example, also in the case of capsule machines which possess several processing tracks, the number of aligning devices 1 can be adjusted and as a result a corresponding supply of aligned tablets can be ensured.

It is understood that the foregoing description is that of the preferred embodiments of the invention and that various changes and modifications may be made thereto without departing from the spirit and scope of the invention as defined in the appended claims.

What is claimed is:

1. An alignment apparatus for tablets, the alignment apparatus comprising:
a shaft configured to be driven about an axis of rotation in a direction of rotation;
a support arranged circumferentially on said shaft;
said shaft being rotatable relative to said support;
said support having a supply channel for a supply of tablets to said shaft;
said shaft defining a circumference;
said shaft defining at least one aligning groove in said circumference for the transport and alignment of a tablet;
said at least one aligning groove having a receiving point and a discharge end;
said aligning groove opening with said discharge end into a receiving pocket for a tablet;
said receiving point of said aligning groove lying at a same position as said supply channel in a direction of the axis of rotation and said discharge end of said aligning groove being arranged laterally offset with respect to said supply channel in the direction of the axis of rotation;
said supply channel and said aligning groove defining a local distance (a) measured in the direction of the axis of rotation;
wherein said local distance (a) increases continuously from said receiving point to said discharge end counter to the direction of rotation of said shaft; and,
said support having a guide track configured to interact with said aligning groove for a guidance of the tablet axially parallel to the axis of rotation of said shaft.

2. The alignment apparatus of claim 1, wherein said aligning groove runs in an arcuate manner from said receiving point towards said discharge end.

3. The alignment apparatus of claim 1, wherein:
said aligning groove has an effective depth measured in a direction radial to the axis of rotation of said shaft; and,
said effective depth increases from said receiving point towards said discharge end counter to the direction of rotation of said shaft.

4. The alignment apparatus of claim 1, wherein said guide track of said support includes an upright supporting wall arranged circumferentially on said shaft parallel to the axis of rotation.

5. The alignment apparatus of claim 1, wherein:
said guide track of said support includes a first delimiting side and a second delimiting side which face one another and run perpendicular to the axis of rotation; and,
said first delimiting side is arranged adjacent to said receiving point and said second delimiting side is arranged adjacent to said discharge end.

6. The alignment apparatus of claim 1 further comprising:
a vacuum supply unit for the provision of a vacuum; and,
said receiving pocket defining an intake bore configured to be connected to said vacuum supply unit in a pressure-transmitting manner.

7. The alignment apparatus of claim 6, wherein said intake bore is surrounded by an intake pocket.

8. The alignment apparatus of claim 1 further comprising a gripping unit for catching a tablet from said receiving pocket.

9. The alignment apparatus of claim 8, wherein said gripping unit includes at least two gripping arms.

10. The alignment apparatus of claim 9, wherein said at least two gripping arms are resilient.
